(19) United States
(12) Patent Application Publication
(10) Pub. No.: US 2022/0377423 A1
(43) Pub. Date: Nov. 24, 2022

(54) INFOTAINMENT SYSTEM FOR REPRODUCING DRM CONTENT

(71) Applicant: LG ELECTRONICS INC., Seoul (KR)

(72) Inventor: Jinkyoung KIM, Seoul (KR)

(73) Assignee: LG ELECTRONICS INC., Seoul (KR)

(21) Appl. No.: 17/773,598

(22) PCT Filed: Nov. 22, 2019
(86) PCT No.: PCT/KR2019/016169

§ 371 Date: Apr. 30, 2022

(30) Foreign Application Priority Data
Oct. 30, 2019 (KR) 10-2019-0136674

(51) Int. Cl. H04N 21/4627; H04N 21/414; G06Q 50/18

(52) U.S. Cl. CPC H04N 21/4627; H04N 21/41422; G06Q 50/184

(57) ABSTRACT

Disclosed is an infotainment system for reproducing DRM content. The infotainment system for reproducing digital rights management (DRM) content of the present disclosure includes a module unit configured to receive the DRM content from a content provider, to reproduce the DRM content, and to convert the reproduced content into an output signal, a vehicle base unit including an interface configured to receive and transmit the output signal, and a display unit configured to display the output signal transmitted through the interface. The infotainment system for reproducing DRM content of the present disclosure has an effect of reproducing DRM content in an in-vehicle infotainment system without breaking laws related thereto.

### TECHNICAL FIELD

The present disclosure relates to an infotainment system for reproducing DRM content in a modular infotainment system.

### BACKGROUND ART

The term “infotainment” is a portmanteau of “information” and “entertainment”, and refers to software or media implemented so as to combine entertainment functions with information delivery.

In particular, an infotainment system for a vehicle, such as an automobile, has a disadvantage in that it is difficult to upgrade, and a modular infotainment system has been developed in order to overcome this disadvantage.

In addition, Digital Rights Management (DRM) technology refers to all kinds of technology for continuously managing and protecting intellectual property rights to digital content using encryption technology. In recent years, DRM technology has been developed all over the world due to copyright enforcement.

Therefore, there is a need for development of an in-vehicle DRM content reproduction system capable of reproducing DRM content.

### DISCLOSURE

### Technical Problem

It is an object of the present disclosure to reproduce DRM content in an in-vehicle infotainment system without breaking laws related thereto.

In addition, it is another object of the present disclosure to reproduce DRM content in an in-vehicle infotainment system using a module structure that is detachably mounted in a vehicle.

### Technical Solution

In order to accomplish the above objects, an infotainment system for reproducing digital rights management (DRM) content according to the present disclosure includes a module unit configured to receive the DRM content from a content provider, to reproduce the DRM content, and to convert the reproduced content into an output signal, a vehicle base unit including an interface configured to receive and transmit the output signal, and a display unit configured to display the output signal transmitted through the interface.

In this case, the module unit may be detachably mounted to the vehicle base unit.

In addition, the module unit may include a coupling portion configured to couple the vehicle base unit to the module unit.

In addition, the module unit may include a transceiver configured to receive the DRM content, a first storage including license information to release DRM of the DRM content, and a first processor configured to release the DRM based on the license information and to reproduce the content.

In this case, the module unit may include a converter, configured to convert the content reproduced by the first processor into the output signal, and an output terminal, configured to encrypt the output signal and to output the encrypted output signal.

In addition, the DRM content may be at least one selected from the group consisting of visual content, auditory content, educational content, interactive content, text content, media content, and image content.

In addition, the vehicle base unit may include a second processor, configured to form media information based on vehicle data, and a link hub, configured to select one of the media information and the output signal and to transmit the selected one to the display unit.

In addition, the content provider may provide the DRM content to the module unit based on V2X communication.

In addition, in order to accomplish the above objects, a method of reproducing DRM content through an infotainment system, including a module unit, a vehicle base unit, and a display unit, includes receiving, by the module unit, the DRM content, releasing, by the module unit, DRM of the DRM content, reproducing, by the module unit, the DRM-released content, converting the reproduced content into an output signal, inputting the output signal to the vehicle base unit, and transmitting the output signal from the vehicle base unit to the display unit and displaying the output signal.

In addition, the receiving may include performing, by the module unit, communication with a road side unit (RSU) and receiving the DRM content from the RSU through V2X communication.

In addition, the releasing may include receiving license information including a unique identifier of a device configured to reproduce the DRM content, comparing the unique identifier with an identifier of the module unit, and releasing, by the module unit, DRM of the DRM content when the identifiers are identical.

In addition, in the inputting, the output signal may be encrypted, and may be input to the vehicle base unit.

In addition, the displaying may include decoding, by the display unit, the encrypted output signal and displaying the output signal on the display unit.

### Advantageous Effects

The in-vehicle infotainment system according to the present disclosure is capable of reproducing DRM content without breaking laws related thereto.

In addition, it may be possible to reproduce DRM content in the modular in-vehicle infotainment system, which is detachably mounted in a vehicle.

The effects achievable through the disclosure are not limited to the above-mentioned effects, and other effects not mentioned herein will be clearly understood by those skilled in the art from the following description.

### DESCRIPTION OF DRAWINGS

FIG. 1 is a block diagram of a wireless communication system to which methods proposed in the present disclosure are applicable.

FIG. 2 illustrates an example of a signal transmission/reception method in a wireless communication system.

FIG. 3 illustrates an example of basic operations of an autonomous vehicle and a 5G network in a 5G communication system.

FIG. 4 illustrates an example of a basic operation between vehicles using 5G communication.

FIG. 5 is an example of V2X communication to which the present disclosure is applicable.

FIG. 6 illustrates a resource allocation method in a sidelink in which V2X is used.

FIG. 7 is a diagram illustrating a procedure for a broadcast mode of V2X communication using PC5.

FIG. 8 is a diagram showing an infotainment system according to a first embodiment.

FIG. 9 is a diagram showing the configuration of a module unit according to the first embodiment.

FIG. 10 is a view showing the external appearance of the module unit according to the first embodiment.

FIGS. 11 to 13 are views showing a coupling portion of the module unit according to the first embodiment.

FIG. 14 is a diagram showing the configuration of a vehicle base unit according to the first embodiment.

FIG. 15 is a diagram showing the configuration of a display unit according to the first embodiment.

FIG. 16 is a diagram showing an example in which the display unit according to the first embodiment is applied to a vehicle.

FIG. 17 is a diagram showing the infotainment system according to the first embodiment, which receives content from a content provider and displays the same.

FIGS. 18 to 20 are diagrams illustrating the infotainment system according to the first embodiment, which displays vehicle data.

FIG. 21 is a diagram illustrating a method of reproducing DRM content through an infotainment system according to a second embodiment.

FIG. 22 is a diagram illustrating a step of releasing DRM of DRM content according to the second embodiment.

The accompanying drawings, which are included herein as a part of the description to help understanding the present disclosure, provide embodiments of the present disclosure, and describe the technical features of the present disclosure with the description below.

### BEST MODE

Hereinafter, embodiments of the present disclosure will be described in detail with reference to the attached drawings. Like reference numerals denote the same or similar components throughout the drawings, and a redundant description of the same components will be avoided. The terms “module” and “unit”, with which the names of components are suffixed, are assigned or used only in consideration of preparation of the specification, and may be interchanged with each other. The terms do not have any distinguishable meanings or roles. A detailed description of a related known technology will be omitted where it is determined that the same would obscure the subject matter of embodiments of the present disclosure. Further, the attached drawings are provided to help easy understanding of embodiments of the present disclosure, rather than to limit the scope and spirit of the present disclosure. Thus, it is to be understood that the present disclosure covers all modifications, equivalents, and alternatives falling within the scope and spirit of the present disclosure.

While ordinal numbers including “first”, “second”, etc. may be used to describe various components, they are not intended to limit the components. These expressions are used only to distinguish one component from another component.

When it is said that a component is “connected to” or “coupled to” another component, it should be understood that the one component may be connected or coupled to the other component directly or through some other component therebetween. On the other hand, when it is said that a component is “directly connected to” or “directly coupled to” another component, it should be understood that there is no other component between the components.

Singular forms include plural referents unless the context clearly dictates otherwise.

In the following description, the term “include” or “have” signifies the presence of a specific feature, number, step, operation, component, part, or combination thereof, but without excluding the presence or addition of one or more other features, numbers, steps, operations, components, parts, or combinations thereof.

A. Example of Block Diagram of UE and 5G Network

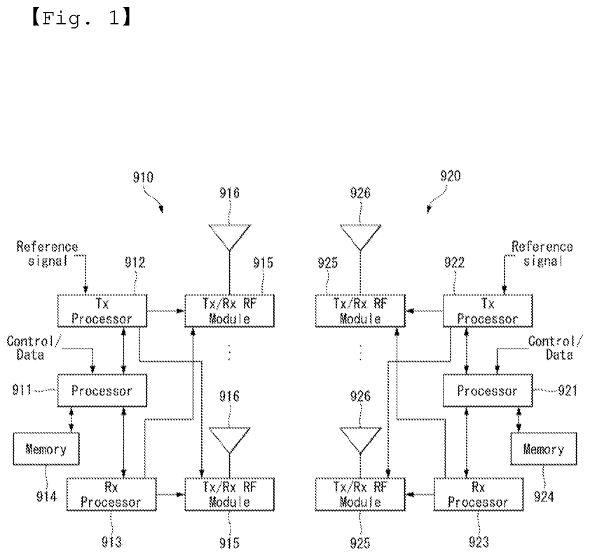

FIG. 1 is a block diagram of a wireless communication system to which methods proposed in the present disclosure are applicable.

Referring to FIG. 1, a device (autonomous device) including an autonomous module is defined as a first communication device (910 in FIG. 1), and a processor 911 may perform detailed autonomous operation.

A 5G network including another vehicle communicating with the autonomous device is defined as a second communication device (920 in FIG. 1), and a processor 921 may perform detailed autonomous operation.

The 5G network may be represented as the first communication device, and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smartphone, a laptop computer, a digital broadcast terminal, a personal digital assistant (PDA), a portable multimedia player (PMP), a navigation device, a slate PC, a tablet PC, an ultrabook, a wearable device (e.g. a smartwatch, a smart glass, and a head mounted display (HMD)), etc. For example, the HMD may be a display device configured to be worn on the head of a user. For example, the HMD may be used to realize VR, AR, or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through a corresponding antenna 926. The processor implements the aforementioned functions, processes, and/or methods. The processor 921 may be related to the memory 924 that stores program code and data. The memory may be referred to as a computer-readable medium. More specifically, the Tx processor 912 implements various signal processing functions with respect to L1 (i.e. physical layer) in DL (communication from the first communication device to the second communication device). The Rx processor implements various signal processing functions of L1 (i.e. physical layer).

UL (communication from the second communication device to the first communication device) is processed in the first communication device 910 in a way similar to that described in association with a receiver function in the second communication device 920. Each Tx/Rx module 925 receives a signal through a corresponding antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

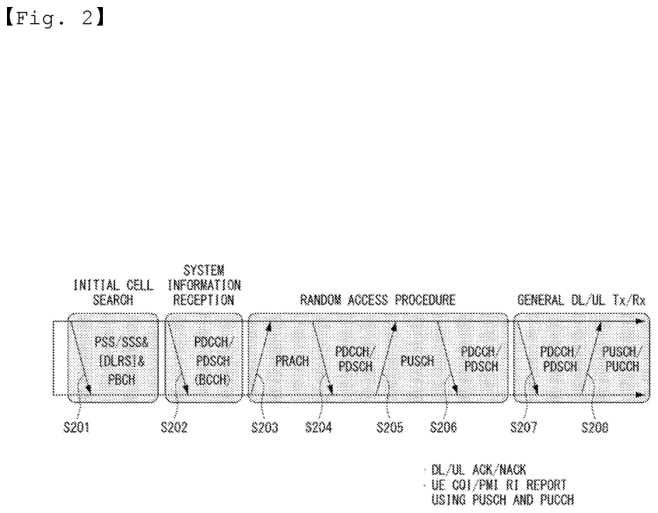

FIG. 2 is a diagram showing an example of a signal transmission/reception method in a wireless communication system.

Referring to FIG. 2, when the UE is powered on or enters a new cell, the UE performs an initial cell search operation such as synchronization with a BS (S201). For this operation, the UE may receive a primary synchronization channel (P-SCH) and a secondary synchronization channel (S-SCH) from the BS to synchronize with the BS, and may acquire information such as a cell ID. In LTE and NR systems, the P-SCH and S-SCH are respectively called a primary synchronization signal (PSS) and a secondary synchronization signal (SSS). After initial cell search, the UE may acquire broadcast information in the cell by receiving a physical broadcast channel (PBCH) from the BS. Further, the UE may receive a downlink reference signal (DL RS) in the initial cell search step to check a downlink channel state. After initial cell search, the UE may acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE may perform a random access procedure (RACH) for the BS (steps S203 to S206). To this end, the UE may transmit a specific sequence as a preamble through a physical random access channel (PRACH) (S203 and S205), and may receive a random access response (RAR) message for the preamble through a PDCCH and a corresponding PDSCH (S204 and S206). In the case of a contention-based RACH, a contention resolution procedure may be additionally performed.

After the UE performs the above-described process, the UE may perform PDCCH/PDSCH reception (S207) and physical uplink shared channel (PUSCH)/physical uplink control channel (PUCCH) transmission (S208) as general uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network may configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate, and performs PDSCH reception or PUSCH transmission on the basis of DCI in the detected PDCCH. The PDCCH may be used to schedule DL transmissions over a PDSCH and UL transmissions over a PUSCH. Here, the DCI in the PDCCH includes downlink assignment (i.e. downlink grant (DL grant)) related to a downlink shared channel and including at least a modulation and coding format and resource allocation information, or an uplink grant (UL grant) related to a uplink shared channel and including a modulation and coding format and resource allocation information.

An initial access (IA) procedure in a 5G communication system will be additionally described with reference to FIG. 2.

The UE may perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS, and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which the UE acquires time/frequency synchronization of a cell and detects a cell identifier (ID) (e.g. physical layer cell ID (PCI)) of the cell. The PSS is used to detect a cell ID in a cell ID group, and the SSS is used to detect a cell ID group. The PBCH is used to detect an SSB (time) index and a half-frame.

There are 336 cell ID groups, and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by the UE during initial cell search is defined as 20 ms. After cell access, the SSB periodicity may be set to one of {5 ms, 10 ms, 20 ms, 40 ms, 80 ms, and 160 ms} by a network (e.g. BS).

Next, acquisition of system information (SI) will be described.

SI is divided into a master information block (MIB) and a plurality of system information blocks (SIBs). SI other than the MIB may be referred to as remaining minimum system information (RMSI). The MIB includes information/parameter for monitoring a PDCCH that schedules a PDSCH carrying SystemInformationBlock1 (SIB1), and is transmitted by a BS through a PBCH of an SSB. SIB1 includes information related to availability and scheduling (e.g. transmission periodicity and SI-window size) of the remaining SIBs (hereinafter, SIBx, x is an integer equal to or greater than 2). SiBx is included in an SI message, and is transmitted over a PDSCH. Each SI message is transmitted within a periodically generated time window (i.e. SI-window).

A random access (RA) procedure in a 5G communication system will be additionally described with reference to FIG. 2.

A random access procedure is used for various purposes. For example, the random access procedure may be used for network initial access, handover, and UE-triggered UL data transmission. The UE may acquire UL synchronization and UL transmission resources through the random access procedure. The random access procedure is classified into a contention-based random access procedure and a contention-free random access procedure. A detailed procedure for the contention-based random access procedure is as follows.

The UE may transmit a random access preamble through a PRACH as Msg1 of a random access procedure in UL. Random access preamble sequences having two different lengths are supported. A long sequence length 839 is applied to subcarrier spacings of 1.25 kHz and 5 kHz, and a short sequence length 139 is applied to subcarrier spacings of 15 kHz, 30 kHz, 60 kHz, and 120 kHz.

When a BS receives the random access preamble from the UE, the BS transmits a random access response (RAR) message Msg2 to the UE. A PDCCH that schedules a PDSCH carrying a RAR is CRC-masked by a random access (RA) radio network temporary identifier (RNTI) (RA-RNTI) and is transmitted. Upon detection of the PDCCH masked by the RA-RNTI, the UE may receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE may be determined according to presence or absence of a random access preamble ID with respect to the preamble transmitted by the UE. If there is no response to Msg1, the UE may retransmit the RACH preamble less than a predetermined number of times while performing power ramping. The UE calculates PRACH transmission power for preamble retransmission on the basis of most recent path loss and a power ramping counter. The UE may perform UL transmission through Msg3 of the random access procedure over a uplink shared channel on the basis of the random access response information. Msg3 may include an RRC connection request and a UE ID. The network may transmit Msg4 as a response to Msg3, and Msg4 may be handled as a contention resolution message on DL. The UE may enter an RRC-connected state by receiving Msg4.

C. Beam Management (BM) Procedure of 5G Communication System A BM procedure may be divided into (1) a DL MB procedure using an SSB or a CSI-RS and (2) a UL BM procedure using a sounding reference signal (SRS). In addition, each BM procedure may include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC CONNECTED.
The UE receives a CSI-ResourceConfig IE including CSI-SSB-ResourceSetList for SSB resources used for BM from a BS.

The RRC parameter “csi-SSB-ResourceSetList” represents a list of SSB resources used for beam management and report in one resource set. Here, an SSB resource set may be set as {SSBx1, SSBx2, SSBx3, SSBx4, . . . }. An SSB index may be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbol(s) as an SSB and ‘QCL-TypeD’ is applicable, the UE may assume that the CSI-RS and the SSB are quasi co-located (QCL) from the viewpoint of ‘QCL-TypeD’. Here, QCL-TypeD may mean that ports of an antenna 111 are quasi co-located from the viewpoint of a spatial Rx parameter. When the UE receives signals of a plurality of ports of the DL antenna 111 in a QCL-TypeD relationship, the same Rx beam may be applied.

Next, a DL BM procedure using a CSI-RS will be described.

An Rx beam determination (or refinement) procedure of UE and a Tx beam swiping procedure of a BS using a CSI-RS will be sequentially described. A repetition parameter is set to ‘ON’ in the Rx beam determination procedure of the UE, and is set to ‘OFF’ in the Tx beam swiping procedure of a BS.

First, the Rx beam determination procedure of the UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resource(s) in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE may skip a CSI report when the RRC parameter ‘repetition’ is set to ‘ON’.

Next, the Tx beam determination procedure of a BS will be described.
The UE receives an NZP CSI-RS resource set IE including an RRC parameter with respect to ‘repetition’ from the BS through RRC signaling. Here, the RRC parameter ‘repetition’ is set to ‘OFF’, and is related to the Tx beam swiping procedure of the BS.
The UE receives signals on resources in a CSI-RS resource set in which the RRC parameter ‘repetition’ is set to ‘OFF’ through different Tx beams (DL spatial domain transmission filters) of the BS.
The UE selects (or determines) the best beam.
The UE reports an ID (e.g. CRI) of the selected beam and related quality information (e.g. RSRP) to the BS. That is, when a CSI-RS is transmitted for BM, the UE reports a CRI and RSRP with respect thereto to the BS.

Next, the UL BM procedure using an SRS will be described.
The UE receives RRC signaling (e.g. SRS-Config IE) including a (RRC parameter) purpose parameter set to ‘beam management” from the BS. The SRS-Config IE is used to set SRS transmission. The SRS-Config IE includes a list of SRS-Resources and a list of SRS-ResourceSets. Each SRS resource set refers to a set of SRS-resources.
The UE determines Tx beamforming for SRS resources to be transmitted on the basis of SRS-SpatialRelation Info included in the SRS-Config IE. Here, SRS-SpatialRelation Info is set for each SRS resource, and indicates whether the same beamforming as that used for an SSB, a CSI-RS, or an SRS will be applied for each SRS resource.
When SRS-SpatialRelationInfo is set for SRS resources, the same beamforming as that used for the SSB, CSI-RS, or SRS is applied. However, when SRS-SpatialRelationInfo is not set for SRS resources, the UE arbitrarily determines Tx beamforming, and transmits an SRS through the determined Tx beamforming.

Next, a beam failure recovery (BFR) procedure will be described.

In a beamformed system, radio link failure (RLF) may frequently occur due to rotation, movement, or beamforming blockage of the UE. Accordingly, NR supports BFR in order to prevent frequent occurrence of RLF. BFR is similar to a radio link failure recovery procedure, and may be supported when the UE knows new candidate beam(s). For beam failure detection, a BS configures beam failure detection reference signals for the UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell, and performs beam failure recovery by selecting a suitable beam (when the BS provides dedicated random access resources for certain beams, these are prioritized by the UE). Completion of the random access procedure is regarded as completion of beam failure recovery.

D. URLLC (Ultra-Reliable and Low Latency Communication)

URLLC transmission defined in NR may refer to (1) a relatively low traffic size, (2) a relatively low arrival rate, (3) extremely low latency requirements (e.g. 0.5 and 1 ms), (4) relatively short transmission duration (e.g. 2 OFDM symbols), and (5) urgent service/message transmission. In the case of UL, transmission of a specific type of traffic (e.g. URLLC) needs to be multiplexed with another transmission (e.g. eMBB) scheduled in advance in order to meet more stringent latency requirements. In this regard, a method of providing information indicating preemption of specific resources to the UE scheduled in advance and allowing a URLLC UE to use the corresponding resources for UL transmission is provided.

NR supports dynamic resource sharing between eMBB and URLLC. eMBB and URLLC services may be scheduled on non-overlapping time/frequency resources, and URLLC transmission may occur in resources scheduled for ongoing eMBB traffic. An eMBB UE may not ascertain whether PDSCH transmission of the corresponding UE has been partially punctured, and the UE may not decode a PDSCH due to corrupted coded bits. In view of this, NR provides a preemption indication. The preemption indication may also be referred to as an interrupted transmission indication.

With regard to the preemption indication, the UE receives DownlinkPreemption IE through RRC signaling from a BS. When the UE receives DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, is configured to have an information payload size for DCI format 2_1 according to dci-Payloadsize, and is configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE may assume that there is no transmission to the UE in PRBs and symbols indicated by the DCI format 2_1 in a set of PRBs and a set of symbols in the last monitoring period before a monitoring period to which the DCI format 2_1 belongs. For example, the UE assumes that a signal in a time-frequency resource indicated according to preemption is not DL transmission scheduled therefor, and decodes data on the basis of signals received in the remaining resource region.

E. Massive MTC (mMTC)

Massive Machine Type Communication (mMTC) is one of 5G scenarios for supporting a hyper-connection service providing simultaneous communication with a large number of UEs. In this environment, the UE intermittently performs communication at a very low transmission speed and mobility. Accordingly, the main goal of mMTC is operating the UE for a long time at a low cost. With respect to mMTC, 3GPP deals with MTC and NarrowBand (NB)-IoT.

mMTC has features such as repetitive transmission of a PDCCH, a PUCCH, a physical downlink shared channel (PDSCH), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period, and the specific information and the response to the specific information may be transmitted/received through a narrowband (e.g. 6 resource blocks (RBs) or 1 RB).

F. Basic Operation between Autonomous Vehicles Using 5G Communication

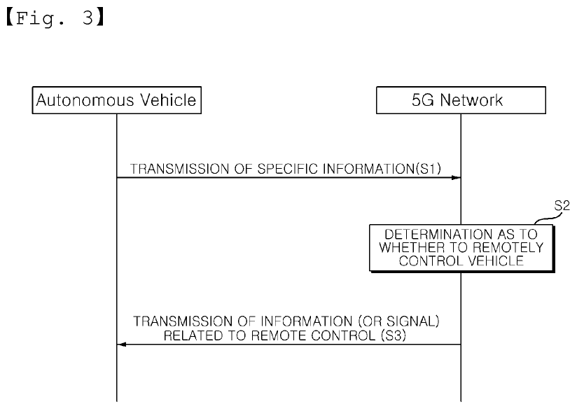

FIG. 3 illustrates an example of basic operations of an autonomous vehicle and a 5G network in a 5G communication system.

The autonomous vehicle transmits specific information to the 5G network (S1). The specific information may include autonomous-driving-related information. In addition, the 5G network may determine whether to remotely control the vehicle (S2). Here, the 5G network may include a server or a module, which performs remote control related to autonomous driving. In addition, the 5G network may transmit information (or a signal) related to remote control to the autonomous vehicle (S3).

G. Applied Operations between Autonomous Vehicle and 5G Network in 5G Communication System

Hereinafter, the operation of an autonomous vehicle using 5G communication will be described in more detail with reference to wireless communication technology (BM procedure, URLLC, Mmtc, etc.) described above with reference to FIGS. 1 and 2.

First, a basic procedure of an applied operation to which a method proposed by the present disclosure, which will be described later, and eMBB of 5G communication are applied will be described.

As in steps S1 and S3 in FIG. 3, the autonomous vehicle performs an initial access procedure and a random access procedure with the 5G network prior to step S1 in FIG. 3 in order to transmit/receive signals, information, and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. In addition, the 5G network may transmit, to the autonomous vehicle, a UL grant for scheduling transmission of specific information.

Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network may transmit, to the autonomous vehicle, information (or a signal) related to remote control on the basis of the DL grant.

Next, a basic procedure of an applied operation to which a method proposed by the present disclosure, which will be described later, and URLLC of 5G communication are applied will be described.

As described above, an autonomous vehicle may receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle may receive a UL grant from the 5G network.

Next, a basic procedure of an applied operation to which a method proposed by the present disclosure, which will be described later, and mMTC of 5G communication are applied will be described.

Description will focus on parts in the steps in FIG. 3 that are changed according to application of mMTC.

In step S1 in FIG. 3, the autonomous vehicle receives a UL grant from the 5G network in order to transmit specific information to the 5G network. Here, the UL grant may include information on the number of repetitions of transmission of the specific information, and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information may be transmitted through a narrowband of 6 resource blocks (RBs) or 1 resource block (RB).

H. Autonomous Driving Operation between Vehicles Using 5G Communication

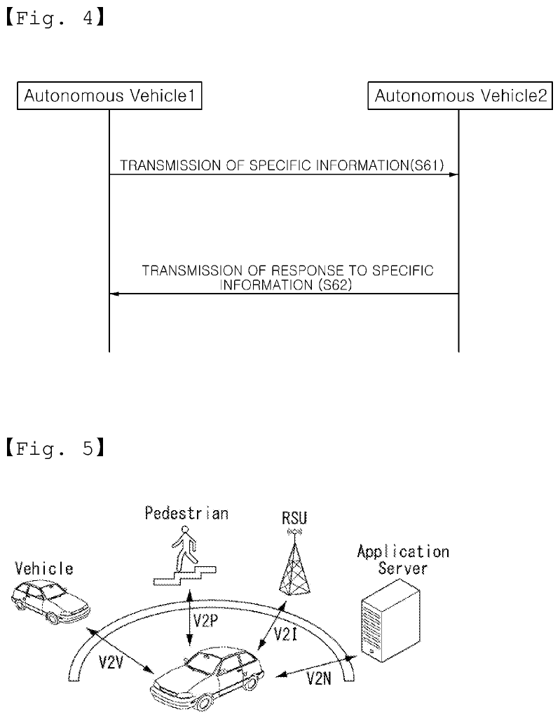

FIG. 4 illustrates an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network may transmit DCI format 5A to the first vehicle for scheduling of mode-3 transmission (PSCCH and/or PSSCH transmission). Here, a physical sidelink control channel (PSCCH) is a 5G physical channel for scheduling of transmission of specific information, and a physical sidelink shared channel (PSSCH) is a 5G physical channel for transmission of specific information. In addition, the first vehicle transmits SCI format 1 for scheduling of specific information transmission to the second vehicle over the PSCCH. Then, the first vehicle transmits the specific information to the second vehicle over the PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window, and the second window refers to a selection window. The first vehicle transmits SCI format 1 for scheduling of transmission of specific information to the second vehicle over the PSCCH on the basis of the selected resources. Then, the first vehicle transmits the specific information to the second vehicle over the PSSCH.

Vehicle-to-Everything (V2X)

FIG. 5 is an example of V2X communication to which the present disclosure is applicable.

The V2X communication includes communication between a vehicle and all objects, such as Vehicle-to-Vehicle (V2V) indicating communication between vehicles, Vehicle-to-Infrastructure (V2I) indicating communication between a vehicle and an eNB or a Road Side Unit (RSU), and Vehicle-to-Pedestrian (V2P) or a Vehicle-to-Network (V2N) indicating communication between a vehicle and UE carried by an individual (a pedestrian, a bicycle rider, a vehicle driver, or a passenger).

The V2X communication may indicate the same meaning as V2X sidelink or NR V2X, or may include a broader meaning including the V2X sidelink or NR V2X.

For example, the V2X communication is applicable to various services such as forward collision warning, an automatic parking system, a cooperative adaptive cruise control (CACC), control loss warning, traffic matrix warning, traffic vulnerable safety warning, emergency vehicle warning, speed warning on a curved road, or a traffic flow control.

The V2X communication may be provided via a PC5 interface and/or a Uu interface. In this case, in a wireless communication system that supports the V2X communication, there may be specific network entities for supporting communication between the vehicle and all objects. For example, the network object may be a BS (eNB), a road side unit (RSU), UE, an application server (e.g. a traffic safety server), or the like.

In addition, the UE executing V2X communication may indicate not only a general handheld UE but also a vehicle UE (V-UE), a pedestrian UE, a BS-type (eNB-type) RSU, a UE-type RSU, a robot having a communication module, or the like.

The V2X communication may be executed directly between UEs, or may be executed through the network object(s). V2X operation modes may be divided according to a method of executing the V2X communication.

The V2X communication requires a support for UE pseudonymity and privacy when a V2X application is used in order to prevent an operator or a third party from tracking a UE identifier within a V2X support area.

Terms frequently used in the V2X communication are defined as follows.
Road Side Unit (RSU): RSU is a V2X serviceable device that is capable of performing transmission/reception with a moving vehicle using a V2I service. Furthermore, the RSU may exchange messages with other entities supporting the V2X application as a fixed infrastructure entity supporting the V2X application. The RSU is a term often used in the existing ITS specifications, and the reason for introducing this term in 3GPP specifications is to make it easy to read a document in an ITS industry. The RSU is a logical entity that combines a V2X application logic with functions of a BS (referred to as a BS-type RSU) or UE (referred to as a UE-type RSU).
V2I service: A type of V2X service in which one is a vehicle and the other is an entity belonging to infrastructure.
V2P service: A type of V2X service in which one is a vehicle and the other is a device carried by an individual (e.g. a handheld UE carried by a pedestrian, a bicycle rider, a driver, or a passenger).
V2X service: A 3GPP communication service type in which a transmitting or receiving device is involved in a vehicle.
V2X-enabled UE: UE supporting V2X service.
V2V service: A type of V2X service in which both in communication are vehicles.
V2V communication range: A range of direct communication between two vehicles participating in V2V service.

As described above, the V2X application, which is referred to as the V2X (Vehicle-to-Everything), includes four types of (1) Vehicle-to-Vehicle (V2V), (2) Vehicle-to-infrastructure (V2I), (3) Vehicle-to-Network (V2N), and (4) Vehicle-to-Pedestrian (V2P).

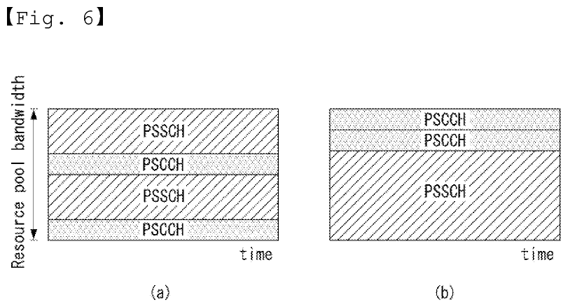

FIG. 6 illustrates a resource allocation method in a sidelink in which V2X is used.

In a sidelink, different physical sidelink control channels (PSCCHs) may be separately allocated in a frequency domain, and different physical sidelink shared channels (PSSCHs) may be separately allocated. Alternatively, different PSCCHs may be allocated consecutively in the frequency domain, and PSSCHs may also be allocated consecutively in the frequency domain.

NR V2X

In order to extend a 3GPP platform to a vehicle industry during 3GPP releases 14 and 15, supports for V2V and V2X services are introduced in LTE.

Requirements for supports with respect to an enhanced V2X use case are broadly divided into four use case groups.

(1) Vehicle platooning enables a platoon in which vehicles move together to be dynamically formed. All of the vehicles in the platoon obtain information from a lead vehicle in order to manage the platoon. The information allows the vehicles to be driven more harmoniously in a normal direction and to travel together in the same direction.

(2) Extended sensors allow raw data or processed data collected through local sensors or live video images to be exchanged between a vehicle, a road site unit, a pedestrian device, and a V2X application server. It is possible to raise environmental awareness beyond what sensors of the vehicle can sense and to extensively and collectively recognize a local situation. A high data transmission rate is one of main features.

(3) Advanced driving enables semi-automatic or fully-automatic driving. It enables each vehicle and/or RSU to share self-awareness data obtained from local sensors with nearby vehicles, and enables each vehicle to synchronize and coordinate a trajectory or maneuver. Each vehicle shares a driving intention with a vehicle that travels nearby.

(4) Remote driving allows a remote driver or a V2X application to drive a remote vehicle for passengers who are unable to drive the remote vehicle on their own or in a dangerous environment. If variability is restrictive and a route can be predicted, like public transportation, driving based on cloud computing may be used. High reliability and a short waiting time are important requirements.

Identifier for V2X Communication via PC5 Each terminal has a Layer-2 identifier for V2 communication through one or more PC5. This includes a source Layer-2 ID and a destination Layer-2 ID.

The source and destination Layer-2 IDs are included in a Layer-2 frame, and the Layer-2 frame is transmitted through a layer-2 link of PC5 identifying a source and a destination of Layer-2 on a frame.

The source and destination Layer-2 ID selection of the terminal is based on a communication mode of the V2X communication of the PC5 of the layer-2 link. The source Layer-2 ID may differ between different communication modes.

If IP-based V2X communication is allowed, the terminal is configured to use a link local IPv6 address as a source IP address. The terminal may use the IP address for V2X communication of PC5, even without sending a Neighbor Solicitation and Neighbor Advertisement message for searching for duplicate addresses.

If one terminal has an active V2X application that requires personal information protection supported in a current geographic area, the source Layer-2 ID may change over time and may be randomized in order for the source terminal (e.g. vehicle) to be tracked or identified from another terminal only for a certain time. In the case of IP-based V2X communication, the source IP address needs also to change over time and to be randomized.

Changes in identifiers of the source terminal need to be synchronized in a layer used for PC5. In other words, if an application layer identifier is changed, the source Layer-2 ID and the source IP address are also required to be changed.

Broadcast Mode

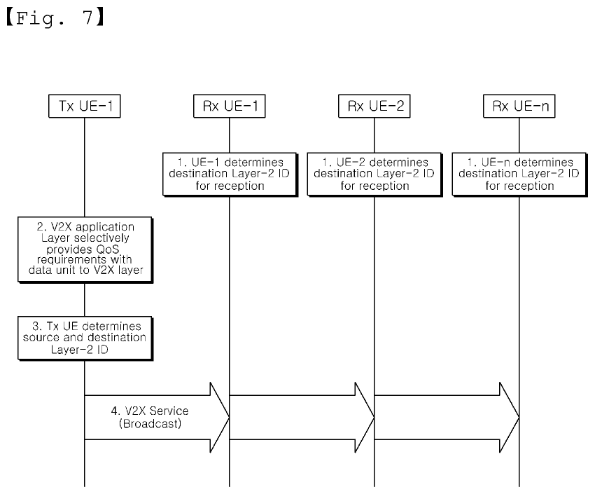

FIG. 7 is a diagram illustrating a procedure for a broadcast mode of V2X communication using PC5.

1. A receiving terminal determines a destination Layer-2 ID for broadcast reception. The destination Layer-2 ID is transmitted to an AS layer of the receiving terminal for reception.

2. A V2X application layer of a transmitting terminal may provide a data unit and V2X application requirements.

3. The transmitting terminal determines the destination Layer-2 ID for broadcast. The transmitting terminal self-assigns a source Layer-2 ID.

4. One broadcast message transmitted by the transmitting terminal transmits V2X service data using the source Layer-2 ID and the destination Layer-2 ID.

Basic Safety Message (BSM) A representative type of standard for encrypting messages transmitted and received in a vehicle communication environment is a basic safety message (BSM) defined in ‘SAE J2735’. The BSM refers to broadcasting messages periodically received from the vehicle, and is designed so as to increase safety. Vehicles transmit messages every 100 msec, and a vehicle that receives the messages determines safety of the vehicle based thereon. The BSM is divided into transmitted information and additional information, which are respectively defined as Part 1 and Part 2. The content of the information may include the location of the vehicle, the movement direction, the current time, and information on the state of the vehicle.

The message ID of the vehicle may be designated as msglD, msgCnt, id, and secMark, and 8 bytes may be allocated thereto. A location value of the vehicle may be designated as lat, long, elev, and accuracy, and 14 bytes may be allocated thereto. Specific values of the field value may refer to ‘SAE J235’.

Table 1 is an example of the BSM that may be applied in the present disclosure.

TABLE 1

| BSMcoreData : : =SEQUENCE { | |
|---|---|
| msgCnt | MsgCount, |
| id | TemporaryID, |
| secMark | DSecond, |
| lat | Latitude, |
| long | Longitude, |
| elev | Elevation, |
| accuracy | PositionalAccuracy, |
| transmission | TransmissionState |
| speed | Speed, |
| heading | Heading, |
| angel | SteeringWheelAngle, |
| accelset | AccelerationSet4Way, |
| brakes | BrakeSystemStatus, |
| size | VehicleSize |
| } | |

In the present disclosure, the BSM may be replaced with a V2X message or a V2X safety message, which performs operation similar thereto.

Digital Rights Management (DRM) A digital rights management (DRM) system may include a content provider, a user, a DRM server, and so on, and may include an electronic payment process, a user authentication process, and a public key infrastructure (PKI).

A general DRM method is to encrypt a content file, to transmit the encrypted file to a user, and then to provide a key that can be used to decrypt the encrypted file only to a valid user having a license. The valid user may be a user who has paid a certain fee to obtain a corresponding license. Here, the key that can be used to decrypt the encrypted file may be transmitted using the public key infrastructure.

In addition, another method of encrypting the content file is to encrypt a transform coefficient (an AC value or a DC value) during a process of encoding a motion picture file.

Infotainment System for Reproducing DRM Content

Hereinafter, an infotainment system for reproducing DRM content according to a first embodiment of the present disclosure will be described in detail based on the above description.

An infotainment system for vehicles (or an in-vehicle infotainment device) is the result of integration of an information system providing information necessary for driving, route guidance, and the like with an entertainment system providing various forms of entertainment and human-friendly functions. The in-vehicle infotainment system may be an in-vehicle system in which a navigation system, an audio/video system, and an Internet system are combined. The in-vehicle infotainment system may be a system in which entertainment and information that can be enjoyed in the vehicle are integrated, and may include devices and technologies providing Internet search, movies, games, TV, social network services (SNSs), navigation, and various services linked to mobile terminals.

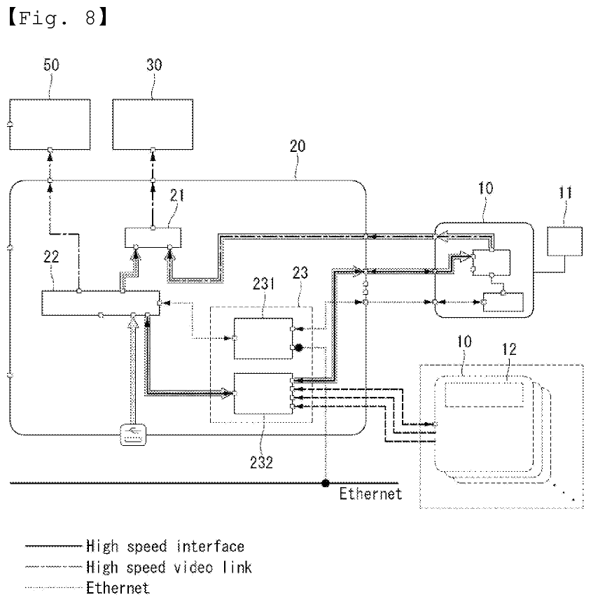

FIG. 8 is a diagram showing an infotainment system according to a first embodiment of the present disclosure.

Referring to FIG. 8, the infotainment system for reproducing DRM content according to the first embodiment of the present disclosure includes a module unit 10, a vehicle base unit 20, and a display unit 30. In addition, the infotainment system may further include a connection unit 40 for interconnecting the module unit 10 and the vehicle base unit 20.

Referring to FIG. 8, the module unit 10 is connected to the vehicle base unit 20 via the connection unit 40. The module unit 10 receives digital rights management (DRM) content from a content provider, reproduces the same, and converts the reproduced content into an output signal. The converted output signal may be input to the vehicle base unit 20.

Referring to FIG. 8, the vehicle base unit 20 includes an interface for receiving and transmitting the converted output signal. The vehicle base unit 20 is connected to the display unit 30, and the display unit 30 displays the content based on the output signal transmitted through the interface of the vehicle base unit 20.

Referring to FIG. 8, the infotainment system for reproducing DRM content may include one module unit 10. Alternatively, referring to FIG. 8, the infotainment system for reproducing DRM content according to the first embodiment of the present disclosure may include a plurality of module units 10. When a plurality of module units 10 is included, the vehicle base unit 20 may include an interface that is connectable to the plurality of module units 10.

Referring to FIG. 8, the infotainment system for reproducing DRM content according to the first embodiment of the present disclosure may include one display unit 30. Alternatively, referring to FIG. 8, the infotainment system for reproducing DRM content according to the first embodiment of the present disclosure may include two display units 30.

Although two display units 30 are illustrated in FIG. 8, the number of display units 30 of the infotainment system according to the present disclosure is not limited thereto.

The display unit 30 is preferably a display unit 30 having a form suitable for the output signal. Specifically, when visual content is transmitted to the infotainment system of the present disclosure, the display unit 30 may output visual information. Further, when auditory content is transmitted to the infotainment system of the present disclosure, the display unit 30 may output sound information. The characteristics of the display unit 30 may also be applied to olfactory content, gustatory content, tactile content, and the like, transmitted to the infotainment system of the present disclosure.

The visual content may be content including pictures, text, images, and the like, and may refer to any type of content that can be visually perceived by humans.

The auditory content may be content including music, voice, dialogue, noise, ASMR, and the like, and may refer to any type of content that is audible to humans.

The content transmitted to the infotainment system according to the first embodiment of the present disclosure may include visual content, auditory content, educational content, interactive content, text content, media content, image content, and the like. Hereinafter, content generated by encrypting the aforementioned content according to digital rights management (DRM) will be referred to as DRM content.

When interactive content is transmitted to the infotainment system according to the first embodiment of the present disclosure, the display unit 30 may not only output content information, but also receive a user's command. For example, the user may input a command using not only an input means such as a keyboard, a mouse, or voice recognition, but also based on an interface such as a virtual keyboard, a virtual mouse, or motion recognition.

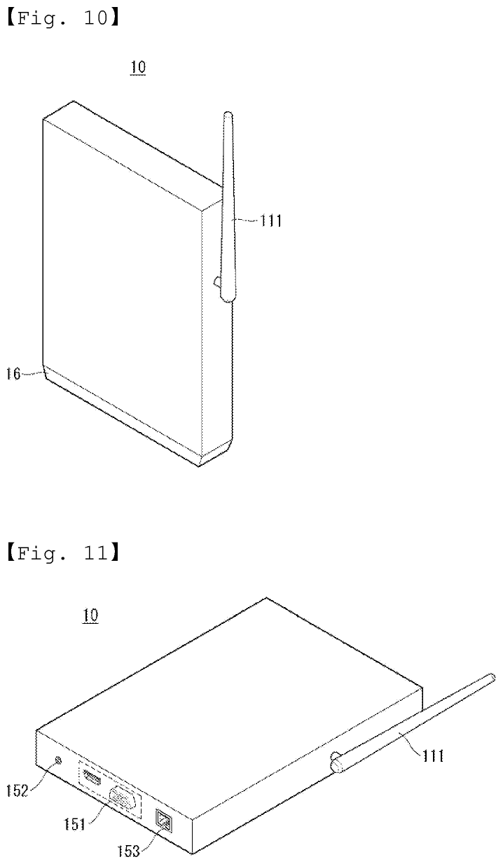

In addition, the infotainment system according to the first embodiment of the present disclosure may further include a connection unit 40 interconnecting the module unit 10 and the vehicle base unit 20. The connection unit 40 may be connected to the vehicle base unit 20, and the module unit 10 may be detachably attached to the connection unit 40. The module unit 10 may include a coupling portion 16, which is formed so as to be easily attached to or detached from the connection unit 40. A concrete embodiment of the coupling portion 16 will be described later with reference to FIGS. 11 to 13.

In this way, the user (or the driver) is capable of enjoying DRM content that is reproduced by the module unit 10 through the vehicle base unit 20 and the display unit 30.

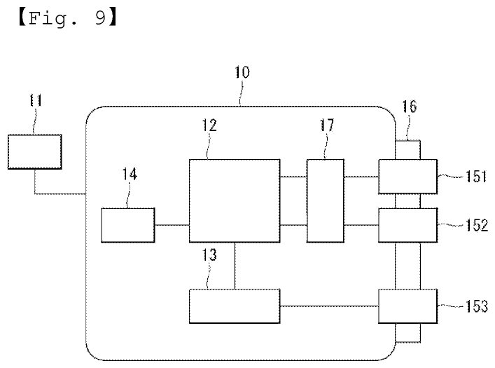

FIG. 9 is a diagram showing the configuration of the module unit according to the first embodiment.

Referring to FIG. 9, the module unit 10 may include a transceiver 11, a first storage 14, and a first processor 12. In addition, the module unit 10 may further include a converter 17 and at least one connection terminal 151, 152, and 153.

Referring to FIG. 9, the module unit 10 may be detachably attached to the vehicle base unit 20. To facilitate attachment and detachment, the module unit 10 may further include a coupling portion 16.

When receiving content from a content provider, the module unit 10 determines whether to apply digital rights management (DRM) to the content. The module unit 10 may communicate with the content provider to receive a list of DRM content or to transmit license information provided in the module unit 10. In this case, the content provider may issue a license to the module unit 10.

The transceiver 11 is configured to enable the module unit 10 and the content provider to communicate with each other, as described above. The transceiver 11 receives content or DRM content from the content provider through wired/wireless communication.

Further, the transceiver 11 may communicate with the content provider through V2X communication. Accordingly, the transceiver 11 may communicate with the content provider through a road side unit (RSU). The details of the V2X communication are the same as those described above with reference to FIGS. 5 to 7, and thus a description thereof will be omitted.

In the case of a transceiver 11 employing wireless communication, the same is connected to an internal/external antenna 111, and transmits and receives information to and from a base station through a mobile phone communication method using the antenna 111. The transceiver 11 employing wireless communication includes a wireless communication module (not shown), which has a modulator, a demodulator, a signal processor, and the like.

Wireless communication is communication that uses communication facilities installed by telecommunications companies and a wireless communication network using a corresponding frequency. In this case, any of various wireless communication systems, such as code division multiple access (CDMA), frequency division multiple access (FDMA), time division multiple access (TDMA), orthogonal frequency division multiple access (OFDMA), and single carrier frequency division multiple access (SC-FDMA), may be used. In addition, 3^{rd} generation partnership project (3GPP) or long term evolution (LTE) may be used. In addition, 5G communication, which has recently been commercialized, may be mainly used, or 6G communication, which is scheduled to be commercialized in the future, may also be used. However, the present disclosure may employ any existing communication network, and is not limited to any one of the above wireless communication methods.

In addition, the transceiver 11 may support an in-vehicle wireless communication function such as Wi-Fi or Bluetooth.

The first storage 14 may include license information capable of deciphering the encrypted DRM content. The first storage 14 may include a hard disk drive (HDD), a solid state disk (SSD), a silicon disk drive (SDD), ROM, RAM, and the like, but the present disclosure is not limited thereto.

The license information stored in the first storage 14 may mean that the module unit 10 including the first storage has the right to use the DRM content. The license information may include a date of purchase of the DRM content, an expiration date, an identifier of the device that purchased the DRM content, an ID of the user who purchased the DRM content, information on the purchased DRM content, and the like.

There are a variety of DRM-related technologies. In general, however, the content provider may transmit license information including a unique identifier of a device capable of reproducing the DRM content together with the DRM content. When the unique identifier is compared with the identifier stored in the first storage 14 of the module unit 10 and the two identifiers are the same, the module unit 10 may release the DRM of the DRM content.

The first processor 12 may include a hardware module capable of releasing the DRM of the DRM content based on the license information. In addition, the first processor 12 may directly reproduce the DRM-free content. That is, the present disclosure is implemented such that the first processor 12, which is a component of the module unit 10, directly reproduces the DRM-free content, thereby overcoming the physical and legal restriction in which the vehicle base unit 20 is incapable of directly reproducing the DRM content.

The first processor 12 is configured to process an input command, to control other devices, and to execute or reproduce content. The first processor 12 may typically be a central processing unit (CPU), an application processor (AP), or the like. In addition, the CPU or the AP may include one or more cores therein, and may operate using an operating voltage and a clock signal.

The module unit 10 may further include a converter 17. When the DRM-free content is reproduced, the converter 17 converts the corresponding content into an output signal. Multimedia content may be converted into an output signal including red, green, and blue (RGB) information, which can be displayed as an image on the display unit 30, sound information, sync information, image format information, frequency information, resolution information, information on devices that can be supported, and the like.

The module unit 10 may further include an output terminal. The output terminal may employ a DVI interface, an S/PDIF interface (an optical method or a coaxial method), and an analog interface. In addition, the output terminal may employ a high-definition multimedia interface (HDMI).

HDMI refers to a scheme of simultaneously transferring a digital image and a sound signal through one cable. HDMI is an interface developed in 2003, and is currently widely used. However, terminals using HDMI may have any of various forms. The HDMI terminal may include a standard HDMI terminal, a mini HDMI terminal, and a micro HDMI terminal.

Further, HDMI keeps evolving, and the bandwidth may vary depending on the HDMI version, for example, HDMI 1.0 (4.95 Gbps), HDMI 1.3 (10.2 Gbps), and HDMI 2.0 (18 Gbps). Therefore, the output terminal according to the present disclosure preferably employs HDMI 2.0.

In addition, the module unit 10 may further include a separate encryption unit, or the output terminal may execute an encryption function. That is, in the process of transmitting the output signal converted by the converter 17, the output signal may be encrypted for security. When the output signal of the DRM-free content is transmitted, the same may be intercepted by a person without a DRM license. Therefore, encryption is required when an image is transmitted.

Here, the most commonly used encryption technology is high-bandwidth digital content protection (HDCP) technology. HDCP is technology for preventing unauthorized copying of information by encrypting content that is transmitted through a digital signal transmission/reception path from an image-reproducing device to a display device such as a display.

Further, the output terminal may employ a SerDes interface. SerDes is the result of integration of a serializer and a deserializer, and may be mainly used for high-speed communication interfaces.

FIG. 10 is a view showing the external appearance of the module unit according to the first embodiment, and FIGS. 11 to 13 are views showing a coupling portion of the module unit according to the first embodiment.

Referring to FIG. 10, the module unit 10 may be provided with an external antenna 111 and a coupling portion 16. Referring to FIG. 10, the external antenna 111 is provided on one surface of the module unit 10, and the coupling portion 16 is provided on another surface of the module unit 10. However, the present disclosure is not limited to the above positions, and the external antenna 111 and the coupling portion 16 may be provided on the same surface.

Referring to FIG. 11, the module unit 10 may be provided on one surface thereof with an output terminal 151. The output terminal 151 may transmit an output signal to the outside. In this case, the output terminal 151 may employ one of a DVI interface, an S/PDIF interface (an optical method or a coaxial method), an analog interface, and a high-definition multimedia interface (HDMI).

Referring to FIG. 11, the module unit 10 may be provided on one surface thereof with an Ethernet terminal 153. When a wired LAN is connected thereto, the Ethernet terminal 153 is capable of transmitting and receiving information through the wired LAN.

Referring to FIG. 11, the module unit 10 may be provided on one surface thereof with an input terminal 152. The input terminal 152 may be a terminal through which the module unit 10 receives power from a battery of the vehicle, or may be a terminal through which data on the vehicle is transmitted from the vehicle base unit to the module unit 10.

Referring to FIG. 11, the terminals of the module unit may be connected with cables that satisfy the specifications of the respective terminals. The cables may be provided at the vehicle base unit 20, and may be connected to respective terminals corresponding thereto. In this case, the coupling portion 16 may not be provided at the module unit 10. The reason for this is that the module unit 10 and the vehicle base unit 20 are connected to each other via the cables, without direct physical coupling therebetween.

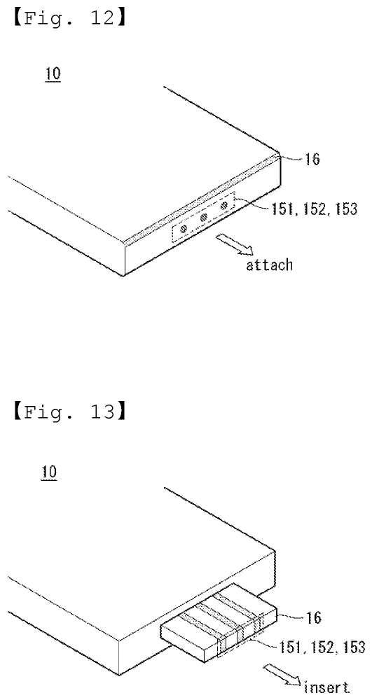

Referring to FIG. 12, the module unit 10 may be provided on one surface thereof with a coupling portion 16. In this case, the coupling portion 16 is provided for coupling between the vehicle base unit 20 and the module unit 10. The coupling portion 16 may be coupled to the connection unit 40 mounted in the vehicle base unit 20, and accordingly, the module unit 10 may be coupled to the vehicle base unit 20.

Referring to FIG. 12, the coupling portion 16 may be provided with an adhesive means corresponding to the connection unit 40. In this case, the adhesive means is preferably an adhesive means using magnetic force or an adhesive means using a sheet of double-sided adhesive tape.

When the coupling portion 16 includes a magnetic material having a specific polarity, the connection unit 40 may include a magnetic material having a polarity opposite the polarity of the magnetic material of the coupling portion 16. Alternatively, when any one of the coupling portion 16 and the connection unit 40 includes a magnetic material, the other thereof may include a metal material, such as steel, to which the magnetic material is attached by magnetic force.

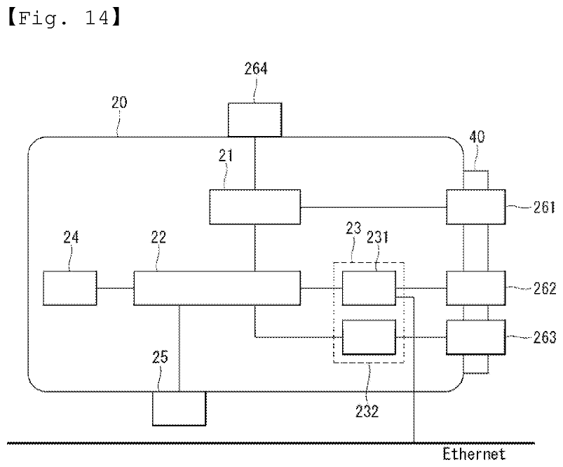

Referring to FIG. 13, the module unit 10 may be provided on one surface thereof with a coupling portion 16. In this case, the coupling portion 16 may be a coupling means using a male/female coupling structure. For example, when the coupling portion 16 includes a male coupling portion 16, the connection unit 40 may include a female coupling portion (not shown) corresponding to the male coupling portion 16. In this case, when the output terminals are exposed to the outside from the male coupling portion 16, the female coupling portion (not shown) may include a plurality of connection terminals (not shown) corresponding to the output terminals.

That is, the coupling portion 16 serves not only as a structure for coupling between the module unit 10 and the vehicle base unit 20 but also as a structure that is electrically connected to the vehicle base unit 20 via the output terminals.

Alternatively, although not shown in FIG. 13, the coupling portion 16 may include a locking protrusion. The connection unit 40 may include an engagement structure that is engaged with the locking protrusion. The user (or the driver) may attach or detach the module unit 10 to or from the vehicle base unit 20 in a manner of engaging or disengaging the locking protrusion with or from the engagement structure.

FIG. 14 is a diagram showing the configuration of the vehicle base unit 20 according to the first embodiment.

Referring to FIG. 14, the vehicle base unit 20 may include a link hub 21, a second processor 22, an interface unit 23, a second storage 24, and an external terminal 25.

The vehicle base unit 20 may include an interface for receiving an output signal from the module unit 10 and transmitting the same.

Further, the vehicle base unit 20 is configured to be embedded in the vehicle, and thus it may be difficult to separate the vehicle base unit 20 from the vehicle. Therefore, the software or the hardware in the vehicle base unit 20 may not be capable of being separately upgraded.

Referring to FIG. 14, the vehicle base unit 20 may include a second processor 22. Basic software for driving the vehicle may be executed using the second processor 22. Specifically, autonomous-driving-related software may be executed using the second processor 22.

The second processor 22 is configured to process an input command, to control other devices, and to execute or reproduce content. The second processor 22 may typically be a central processing unit (CPU), an application processor (AP), or the like. In addition, the CPU or the AP may include one or more cores therein, and may operate using an operating voltage and a clock signal. The second processor 22 is the same as or similar to the first processor 12 described above. However, the second processor 22 may need a higher clock rate and higher calculation performance than the first processor 12 because the second processor 22 may be directly related to travel of the vehicle.

Referring to FIG. 14, the second processor 22 may execute software stored in the second storage 24. Software necessary for travel of the vehicle may be stored in the second storage 24. Specifically, a GPS operation program, a navigation program, a program capable of implementing a signal input to the external terminal 25, a program capable of collecting and organizing vehicle data related to travel of the vehicle, and a driving assistance program for a driver may be stored in the second storage 24.

The second processor 22 may execute software stored in the second storage 24, and may form media information based on vehicle data measured from the outside. The media information may be all kinds of image/sound information that is displayed to enable the driver to recognize the driving speed, the driving distance, the navigation, and the like.

The vehicle data may be driving information including the driving speed of the vehicle, including the infotainment system according to the first embodiment of the present disclosure, the driving distance, the location, the driver information, and the image information obtained by an external camera provided in the vehicle.

Referring to FIG. 14, the vehicle base unit 20 may include a link hub 21. The link hub 21 may be configured to select any one of the media information transmitted from the second processor 22 and the output signal transmitted from the first processor 12 and to transmit the selected result to the display unit 30. That is, the infotainment system user (or the driver) may select which one to check from among two pieces of information input to the single display unit 30. In this case, when the user selects one piece of information, only the selected information may be output through the link hub 21.

However, in some cases, the user may select whether to display both pieces of information on the single display unit 30 in a split manner or in an overlapping manner. In this case, the link hub 21 may output information according to the selection by the user.

Referring to FIG. 14, the vehicle base unit 20 may include an interface unit 23. The interface unit 23 may include an interface for transmitting the output signal received from the module unit 10 to the outside or to other components. Since the vehicle base unit 20 according to the present disclosure transmits high-volume content, the vehicle base unit 20 may include a high-speed interface. A peripheral component interconnect (PCI)-based interface may be mainly used as the high-speed interface.

The peripheral component interconnect (PCI)-based interface employs a packet-based serial switch structure, rather than a conventional message-based parallel shared bus structure, and at present is typically embodied as PCI-Express (PCIe).

That is, PCI-Express (PCIe) refers to an interface that changes the current data transmission method to a serial signal transmission method and increases a data transmission speed while reducing the bus width in order to overcome the limitations of the conventional parallel signal transmission method. A PCI-Express (PCIe) cable may be generally composed of a total of eighteen pins. Among the eighteen pins, pins corresponding to Tx and Rx pairs and three or four GND pins may be used for transmission of signals.

Referring to FIG. 14, the interface unit 23 may include an Ethernet chip 231 or a high-speed interface terminal 232. The Ethernet chip 231 of the interface unit 23 may be connected to the Ethernet chip 13 of the module unit 10 in a wired manner.

Referring to FIG. 14, the vehicle base unit 20 may include a plurality of input/output terminals.

The vehicle base unit 20 may further include an input terminal 261 for receiving the output signal transmitted from the module unit 10, an Ethernet terminal 262, and a connection terminal 263 interconnecting the interface unit 23 and the module unit 10.

Referring to FIG. 14, the vehicle base unit 20 may further include an output terminal 264 for outputting a signal selected by the link hub 21 from among the media information transmitted from the second processor 22 and the output signal transmitted from the module unit 10.

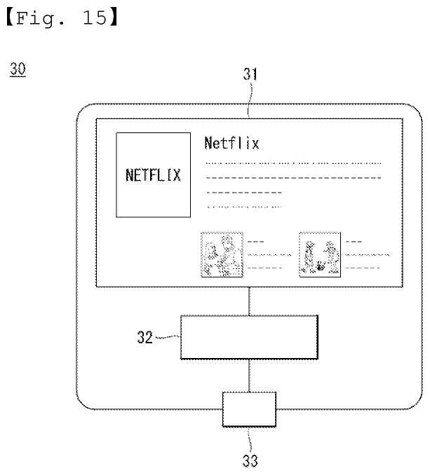

FIG. 15 is a diagram showing the configuration of the display unit according to the first embodiment.

Referring to FIG. 15, the display unit 30 may include a display, an input terminal 33, and a decoding unit 32.

The display included in the display unit 30 may be implemented as a light-emitting diode (LED), an organic LED (OLED), a light-emitting polymer (LEP), a polymer LED (PLED), a liquid crystal display (LCD), a thin-film transistor (TFT) LCD, plasma, electronic paper, e-ink, or a combination thereof.

In addition, the display may include a touch panel, so the user (or the driver) may input a command through the display. In this case, a user interface may be displayed on the display.

The input terminal 33 may be a terminal for receiving a signal input from the vehicle base unit 20. When a signal encrypted using HDCP or the like is input from the input terminal 33 to the display unit 30, the decoding unit 32 confirms the encrypted state, and then decodes the encrypted signal according to the type of encryption. The decoded signal may be displayed on the display 31.

When the signal input from the input terminal 33 to the display unit 30 is not encrypted using HDCP or the like, the decoding unit 32 confirms the non-encrypted state, and then transmits the input signal to the display 31.

Although one display unit 30 is illustrated in FIG. 15, it will be apparent that the infotainment system according to the present disclosure is capable of including a plurality of display units 30.

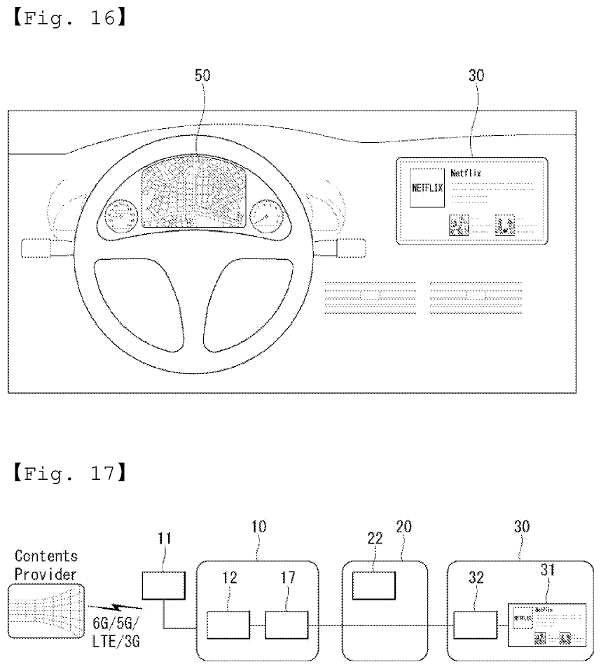

FIG. 16 is a diagram showing an example in which the display unit 30 according to the first embodiment is applied to a vehicle.

Referring to FIG. 16, the display unit 30 may include a first display unit 30 for displaying information selected from the link hub 21 and a second display unit 50 for displaying cluster information. According to the recent trend toward increasingly large displays in vehicles, various pieces of information, which are displayed on the first display unit 30 and the second display unit 50, may be displayed on a single display in a split manner.

In addition, although not shown in FIG. 16, a third display unit (not shown) to an n^{th} display unit (not shown) may be further included in some cases.

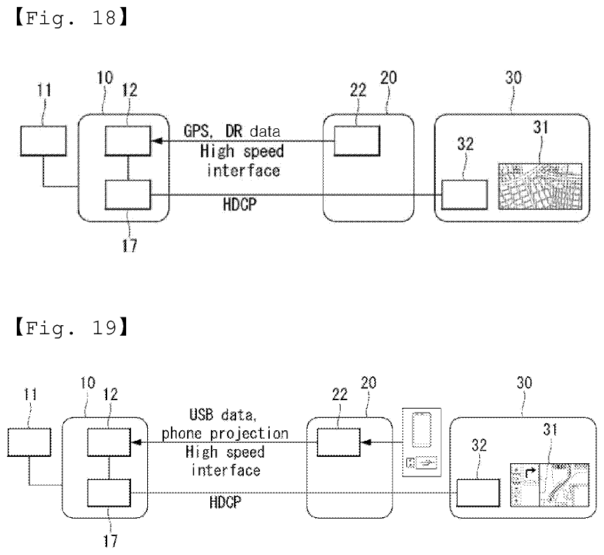

FIG. 17 is a diagram showing the infotainment system according to the first embodiment, which receives content from a content provider and displays the same.

Referring to FIG. 17, the content provider may communicate with the module unit 10 of the present disclosure, and the module unit 10 may reproduce DRM content. It can be understood that the vehicle base unit 20 and the display unit 30 of the present disclosure are media interconnecting the module unit 10 and the user (or the driver) so that the user (or the driver) is capable of recognizing the DRM content.

The content provider mentioned throughout the present disclosure may collectively refer to a system or a central server including a DRM content providing server, a license providing server, and a license checking server.

In this case, the system or the server may be operated by a company providing a multimedia service, represented by Netflix, YouTube, and the like, or an individual providing a multimedia service in a manner similar thereto.

FIGS. 18 to 20 are diagrams illustrating the infotainment system according to the first embodiment, which displays vehicle data.

The infotainment system according to the first embodiment of the present disclosure may reproduce DRM content, and may display the same on the display unit 30. In addition, the infotainment system according to the first embodiment of the present disclosure may display not only DRM content but also content input through the external terminal 25 and information content containing vehicle data on the display unit 30.

Referring to FIG. 18, GPS information or DR data from the second processor 22 of the vehicle base unit 20 of the present disclosure may be converted into content, and the content may be transmitted to the module unit 10 through the high-speed interface. In this case, the content may be transmitted to the display unit 30 through the module unit 10 along the same route as the DRM content.

Referring to FIG. 19, the external terminal 25 of the vehicle base unit 20 of the present disclosure may be connected to a third device. In this case, the third device may be an electronic device such as a USB storage device or a smartphone of the user (or the driver). In this case, information input through the external terminal 25 may be input to the second processor 22 of the vehicle base unit 20. The second processor 22 may convert information input through the external terminal 25 into content, and the corresponding content may be transmitted to the display unit 30 through the module unit 10 along the same route as the DRM content.

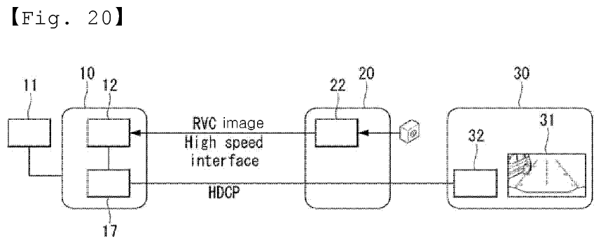

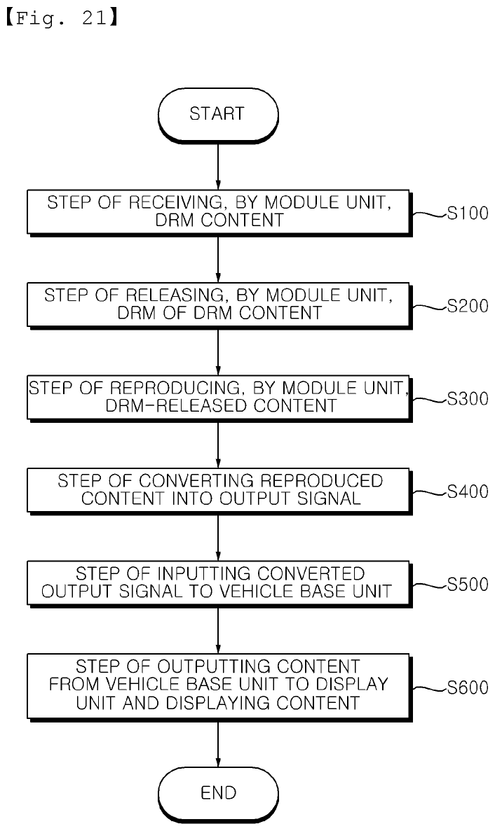

Referring to FIG. 20, the external terminal 25 of the vehicle base unit 20 of the present disclosure may be connected to a third device. In this case, the third device may be a camera mounted on the outside of the vehicle to capture information outside the vehicle. In this case, the captured image input through the external terminal 25 may be input to the second processor 22 of the vehicle base unit 20. The second processor 22 may reprocess the captured image using software stored in the second storage 24. The reprocessed image may be transmitted to the display unit 30 through the module unit 10 along the same route as the DRM content.

Specific Application of First Embodiment

Examples of specific application of the infotainment system for reproducing DRM content according to the first embodiment of the present disclosure are as follows.

First, the user is capable of enjoying DRM content by mounting the module unit 10 according to the present disclosure to the infotainment system provided in the vehicle. Content providers have policies forbidding reproduction of DRM content by directly using a computing system provided in a vehicle, and violating such policies may cause legal problems.

Second, in addition to the first example, in which it is possible to reproduce DRM content using the in-vehicle infotainment system merely by mounting the module unit 10 in the vehicle, the module unit 10 is capable of being detachably mounted in the vehicle, and thus the user is capable of replacing the module unit 10. Alternatively, it is possible to mount a plurality of module units 10.

Third, various devices may be attached to the module unit 10. For example, when interactive content is provided as DRM content, the module unit 10 may be further provided with a device capable of recognizing the motion of the user, a device capable of recognizing the voice of the user, or a device capable of recognizing the fingerprint or iris of the user.

Fourth, the vehicle equipped with the module unit 10 may be an autonomous vehicle. Autonomous driving is being commercialized with the development of communication technology such as 5G and the development of AI, and a driver of an autonomous vehicle may focus on infotainment and enjoy the same. Accordingly, the present disclosure may be applied for drivers of autonomous vehicles.

Fifth, when the module unit 10 is mounted in the vehicle, the area in which DRM content is reproduced may be provided for a passenger, rather than a driver. Accordingly, the display on which the content is displayed may be mounted at a position that is not easily viewed from the driver's seat.

Sixth, the user may use various streaming services through the module unit 10. The streaming services may include not only image-oriented multimedia content but also music content enabling the user to listen to digital music. Seventh, the content that is reproduced through the module unit 10 is not limited to DRM content.

Eighth, the streaming service included in the module unit 10 is not limited to infotainment. Specifically, when it is necessary to use a medical service, personal health information may be encrypted and transmitted/received. As such, when important information containing encrypted data or security data is transmitted/received, the system of the present disclosure may be applied thereto.

Method of Reproducing DRM Content through Infotainment System

Hereinafter, a method of reproducing DRM content through an infotainment system according to a second embodiment of the present disclosure will be described in detail on the basis of the above description.

For reference, in the second embodiment of the present disclosure, a description of components having features the same as or similar to those of the first embodiment of the present disclosure will be omitted, and only differences from the first embodiment will be described.

Further, a method of reproducing DRM content through the infotainment system according to the second embodiment of the present disclosure may be the reproduction method implemented by the infotainment system for reproducing DRM content according to the first embodiment of the present disclosure.

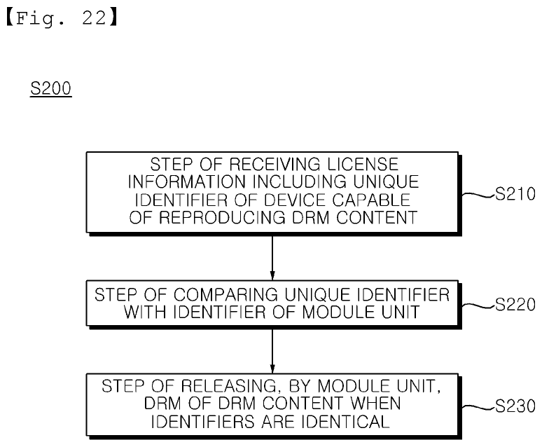

FIG. 21 is a diagram illustrating a method of reproducing DRM content through the infotainment system according to the second embodiment.

Referring to FIG. 21, the method includes steps of receiving, by the module unit 10, DRM content (S100), releasing, by the module unit 10, DRM of the received DRM content (S200), reproducing, by the module unit 10, the DRM-released content (S300), converting the reproduced content into an output signal (S400), inputting the converted output signal to the vehicle base unit 20 (S500), and transmitting the output signal from the vehicle base unit 20 to the display unit 30 and displaying the output signal on the display unit 30 (S600).

In this case, the step of receiving, by the module 10, the DRM content (S100) may include steps of performing, by the module unit 10, communication with the road side unit (RSU) (S110) and receiving the DRM content from the RSU through V2X communication (S120).

In addition, the step of inputting the converted output signal to the vehicle base unit 20 (S500) may include steps of encrypting the output signal using an HDCP protocol (S410) and inputting the output signal encrypted using the HDCP protocol to the vehicle base unit 20 (S420).

In addition, the step of transmitting the output signal from the vehicle base unit 20 to the display unit 30 and displaying the output signal on the display unit 30 (S600) may include steps of decoding the HDCP-encrypted output signal (S510) and displaying the decoded output signal on the display unit 30 (S520).

FIG. 22 is a diagram illustrating a step of releasing DRM of DRM content according to the second embodiment.

Referring to FIG. 22, the step of releasing DRM of the DRM content (S200) according to the second embodiment of the present disclosure may include steps of receiving license information including a unique identifier of a device capable of reproducing the DRM content (S210), comparing the unique identifier with the identifier of the module unit 10 (S220), and releasing, by the module unit 10, DRM of the DRM content when the two identifiers are the same (S230).

That is, when a license to release DRM of the DRM content is granted and the DRM content is transmitted, the corresponding device may also transmit license information for releasing DRM of the DRM content.

The license information may include a date of purchase of the DRM content, an expiration date, an identifier of the device that purchased the DRM content, an ID of the user who purchased the DRM content, information on the purchased DRM content, and the like.

The above-described present disclosure may be implemented as computer-readable code stored on a computer-readable recording medium. The computer-readable recording medium may be any type of recording device in which data is stored in a computer-readable manner. Examples of the computer-readable recording medium include a Hard Disk Drive (HDD), a Solid-State Disk (SSD), a Silicon Disk Drive (SDD), ROM, RAM, a CD-ROM, a magnetic tape, a floppy disk, an optical data storage, a carrier wave (e.g. transmission via the Internet), etc. The above embodiments are therefore to be construed in all aspects as illustrative and not restrictive. The scope of the disclosure should be determined by reasonable interpretation of the appended claims, and all equivalent modifications made without departing from the disclosure should be considered to be included in the following claims.

While the present disclosure has been particularly shown and described with reference to exemplary embodiments thereof, these embodiments are only proposed for illustrative purposes and do not restrict the present disclosure, and it will be apparent to those skilled in the art that various changes in form and detail may be made without departing from the essential characteristics of the embodiments set forth herein. For example, respective configurations set forth in the embodiments may be modified and applied. Further, differences in such modifications and applications should be construed as falling within the scope of the present disclosure as defined by the appended claims.

Although the present disclosure has been described above with reference to application to autonomous driving systems (automated vehicle & highway systems) based on a 5th generation (5G) system, the present disclosure may also be applied to various other wireless communication systems and autonomous driving apparatuses.

Description of Reference Numerals

| | | | |
|---|---|---|---|
| 10: | module unit | 11: | transceiver |
| 111: | antenna | 12: | first processor |
| 14: | first storage | 16: | coupling portion |
| 20: | vehicle base unit | 21: | link hub |
| 22: | second processor | 23: | interface unit |
| 24: | second storage | 30: | display unit |

1. An in-vehicle infotainment system for reproducing digital rights management (DRM) content, the in-vehicle infotainment system comprising:
a module unit configured to receive the DRM content from a content provider, to reproduce the DRM content, and to convert the reproduced content into an output signal;
a vehicle base unit comprising an interface configured to receive and transmit the output signal; and
a display unit configured to display the output signal transmitted through the interface,
wherein the module unit is connected to the vehicle base unit, and
wherein the module unit comprises:
a transceiver configured to receive the DRM content;
a first storage including license information to release DRM of the DRM content and
a first processor configured to release the DRM based on the license information and to reproduce the content.

2. The in-vehicle infotainment system according to claim 1,
wherein the module unit is detachably mounted to the vehicle base unit.

3. The in-vehicle infotainment system according to claim 2,
wherein the module unit comprises:
a coupling portion configured to couple the vehicle base unit to the module unit.

4. (canceled)

5. The in-vehicle infotainment system according to claim 1, wherein the module unit comprises:
a converter configured to convert the content reproduced by the first processor into the output signal; and
an output terminal configured to encrypt the output signal and to output the encrypted output signal.

6. The in-vehicle infotainment system according to claim 1, wherein the DRM content is at least one selected from a group consisting of visual content, auditory content, educational content, interactive content, text content, media content, and image content.

7. The in-vehicle infotainment system according to claim 1, wherein the vehicle base unit comprises:
a second processor configured to form media information based on vehicle data; and
a link hub configured to select one of the media information and the output signal and to transmit the selected one to the display unit.

8. The in-vehicle infotainment system according to claim 1, wherein the content provider provides the DRM content to the module unit based on V2X communication.

9. A method of reproducing DRM content through an in-vehicle infotainment system comprising a module unit, a vehicle base unit, and a display unit, the method comprising:
receiving, by the module unit, the DRM content;
releasing, by the module unit, DRM of the DRM content;
reproducing, by the module unit, the DRM-released content;
converting the reproduced content into an output signal;
inputting the output signal to the vehicle base unit; and
transmitting the output signal from the vehicle base unit to the display unit and displaying the output signal,
wherein the module unit is connected to the vehicle base unit, and receives and stores license information to release DRM of the DRM content, and
wherein the releasing comprises:
releasing the DRM based on the license information.

10. The method according to claim 9, wherein the receiving comprises:
performing, by the module unit, communication with a road side unit (RSU); and
receiving the DRM content from the RSU through V2X communication.

11. The method according to claim 9, wherein the license information includes a unique identifier of a device configured to reproduce the DRM content, and
wherein the releasing comprises:
comparing the unique identifier with an identifier of the module unit; and
releasing, by the module unit, DRM of the DRM content when the unique identifier and the identifier of the module unit are identical.

12. The method according to claim 9, wherein, in the inputting, the output signal is encrypted, and is input to the vehicle base unit.

13. The method according to claim 12, wherein the displaying comprises:
decoding, by the display unit, the encrypted output signal; and
displaying the output signal on the display unit.
